(19) United States
(12) Patent Application Publication
(10) Pub. No.: US 2020/0104834 A1
(43) Pub. Date: Apr. 2, 2020

(54) USING A CUSTOMER ID IN A MOBILE WALLET TO MAKE A TRANSACTION

(71) Applicant: Comenity LLC, Columbus, OH (US)

(72) Inventors: Timothy D. PONTIOUS, Gahanna, OH (US); Christina MOSHOLDER, Powell, OH (US); Christian BILLMAN, Gahanna, OH (US)

(73) Assignee: Comenity LLC, Columbus, OH (US)

(21) Appl. No.: 16/591,384

(22) Filed: Oct. 2, 2019

Related U.S. Application Data
(60) Provisional application No. 62/740,255, filed on Oct. 2, 2018.

(51) Int. Cl. G06Q 20/36; G06Q 20/32; G06Q 20/38; G06Q 20/40

(52) U.S. Cl. CPC G06Q 20/363; G06Q 20/3674; G06Q 2220/00; G06Q 20/3821; G06Q 20/4014; G06Q 20/322

(57) ABSTRACT

A system and method for using a customer ID stored in a mobile wallet to facilitate a transaction is disclosed. The method stores, at a memory of a mobile device, a metadata file formatted for the mobile wallet on the mobile device, the metadata file includes an image of a customer's ID and a token. The metadata file is opened in the mobile wallet by one or more processors of the mobile device. When the metadata file is opened, an image of a customer's ID and a token is presented by the customer's mobile device. The presentation of the image of the customer's ID and the token on the mobile device is used to facilitate payment at a point-of-sale.

### CROSS-REFERENCE TO RELATED APPLICATIONS (PROVISIONAL)

This application claims priority to and benefit of co-pending U.S. Provisional Patent Application No. 62/740,255 filed on Oct. 2, 2018, entitled “USING A CUSTOMER ID IN A MOBILE WALLET TO MAKE A TRANSACTION” by Pontious et al., and assigned to the assignee of the present application, the disclosure of which is hereby incorporated by reference in its entirety.

### BACKGROUND

Credit card companies often require merchants to check the picture identification of a person using a credit card issued by their company. These requirements help to reduce credit card fraud. However, these requirements are also burdensome and time consuming for the merchant and the customer alike. Additionally, a customer could have numerous different cards for credit accounts, reward memberships, offers, coupons, and the like. If the customer forgets to take one or all of their credit cards with them while shopping, many times they are not able to purchase a desired item, utilize an available reward during the purchase, utilize the merchant's coupon, etc.

### BRIEF DESCRIPTION OF THE DRAWINGS

The accompanying drawings, which are incorporated in and form a part of this specification, illustrate various embodiments and, together with the Description of Embodiments, serve to explain principles discussed below. The drawings referred to in this brief description should not be understood as being drawn to scale unless specifically noted.

FIG. 1 is a block diagram of a mobile device, in accordance with an embodiment.

FIG. 2 is a block diagram of a system for adding a customer ID with purchase capability to a mobile wallet, in accordance with an embodiment.

FIG. 3 is a flow diagram of a method for utilizing an image of a customer's ID, in a mobile wallet of a mobile device, to make a transaction, in accordance with an embodiment.

FIG. 4 is a process flow diagram for providing biometric security to determine that the customer who is utilizing the mobile device is actually the customer whose ID is being provided via the mobile wallet, in accordance with an embodiment.

FIG. 5 is a block diagram of an example computer system with which or upon which various embodiments of the present invention may be implemented.

### DESCRIPTION OF EMBODIMENTS

Reference will now be made in detail to embodiments of the subject matter, examples of which are illustrated in the accompanying drawings. While the subject matter discussed herein will be described in conjunction with various embodiments, it will be understood that they are not intended to limit the subject matter to these embodiments. On the contrary, the presented embodiments are intended to cover alternatives, modifications and equivalents, which may be included within the spirit and scope of the various embodiments as defined by the appended claims. Furthermore, in the Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

### Notation and Nomenclature

Unless specifically stated otherwise as apparent from the following discussions, it is appreciated that throughout the present Description of Embodiments, discussions utilizing terms such as “selecting”, “outputting”, “inputting”, “providing”, “receiving”, “utilizing”, “obtaining”, “updating”, “accessing”, “changing”, “deciding”, “determining”, “interacting”, “searching”, “pinging” or the like, often refer to the actions and processes of an electronic computing device/system, such as a desktop computer, notebook computer, tablet, mobile phone, and electronic personal display, among others. The electronic computing device/system manipulates and transforms data represented as physical (electronic) quantities within the circuits, electronic registers, memories, logic, and/or components and the like of the electronic computing device/system into other data similarly represented as physical quantities within the electronic computing device/system or other electronic computing devices/systems.

It should be appreciated that the obtaining, accessing, or utilizing of information conforms to applicable privacy laws (e.g., federal privacy laws, state privacy laws, etc.).

### Overview

The discussion provides a novel method for adding a tender vehicle to a mobile wallet on a user's mobile device. In one embodiment, the tender vehicle is a pass and not a card. In one embodiment, the tender vehicle is based on a customer's ID (e.g., a digitized version of the customer's ID) and is placed in the mobile wallet and linked to one or more of a plurality of payment options such as store brand credit accounts, rewards accounts, coupons, offers, non-branded credit accounts, etc.

Importantly, the embodiments of the present invention, as will be described below, provide an approach for mobile wallet utilization which differs significantly from the conventional processes used to provide payment information, rewards information, coupon information and the like, during a transaction. In conventional approaches, the credit/reward/coupons were found in one or more of a combination of a piece of plastic, a piece of paper, an electronic mail, an attachment to an email, a mailer, a plurality of different applications on a mobile device, a plurality of different cards in a mobile wallet, and the like. As such, it was likely that a customer would not have (or easily access, find, etc.) one or more coupons/rewards/credit accounts, etc. available to them at the time of purchase. For example, the coupons and rewards could be in pockets, in emails, spread through a plurality of applications on the customer's mobile device, etc.

Since the customer receives offers, coupons, rewards memberships, and different credit accounts via the mail, register receipts, electronic aspects (e.g., email, mobile cards in a mobile wallet, etc.) via the internet, and the like, the ability to track and properly utilize different credit accounts, coupons, offers, rewards, points, and the like cannot be simply adjusted to use on a computing device or handled over a network. Instead, the present embodiments described herein, require a completely new and different system than that which was is presently used. Moreover, ensuring that the customer's appropriate credit account, rewards, offers, coupons and the like are available and used at the time of transaction is different than even the present use of mobile payment that is performed at the point of sale (POS). For example, even when paying electronically, the paper receipt is handed to the customer and includes a number of offers, coupons, etc. Further, even if the receipt is electronically provided, it is emailed, texted or the like and will often not include the offers that are provided on the paper receipt. As such, a new and different solution that is completely network-centric is disclosed.

For example, finding the appropriate paper, plastic, or electronic credit account, reward information, coupons and the like is tedious, time-consuming, and often causes worry or concern if the appropriate items cannot be quickly found at the time of checkout. Especially if there is a line of other customers waiting. In many cases, the customer simply forgoes finding the proper credit account, coupon, reward, or the like in order to not hold up the line, feel the stares of other customers, or the like. However, the present embodiments, as will be described and explained below in detail, provide a previously unknown and Internet-centric procedure for obtaining and utilizing a single tender vehicle (e.g., a customer ID) in the mobile wallet of the customer's mobile device to provide a customer with the appropriate credit account, rewards, coupons, and offers at the time of purchase.

Thus, embodiments of the present invention provide a capability to link credit accounts, reward accounts, coupons, offers, and the like, which is completely different than what was previously done because of the Internet-centric centralized aspect of the mobile wallet ID.

As will be described in detail, the various embodiments of the present invention do not merely implement conventional mobile payment processes on a mobile device. Instead, the various embodiments of the present invention, in part, provide a novel process for utilizing a single mobile wallet ID to provide some or all aspects of the purchasing process, which is necessarily rooted in Internet-centric computer technology to overcome a problem specifically arising in the realm of mobile device electronic payment.

Moreover, the embodiments do not recite a mathematical algorithm; nor do they recite a fundamental economic or longstanding commercial practice. Instead, they address a business challenge that has been born in the Internet-centric environment. Thus, the embodiments do not “merely recite the performance of some business practice known from the pre-Internet world along with the requirement to perform it on [a computing device].” Instead, the embodiments are necessarily rooted in network-centric environments in order to overcome new problems specifically arising in the realm of mobile payment with respect to credit accounts, rewards, offers, and the like.

### Operation

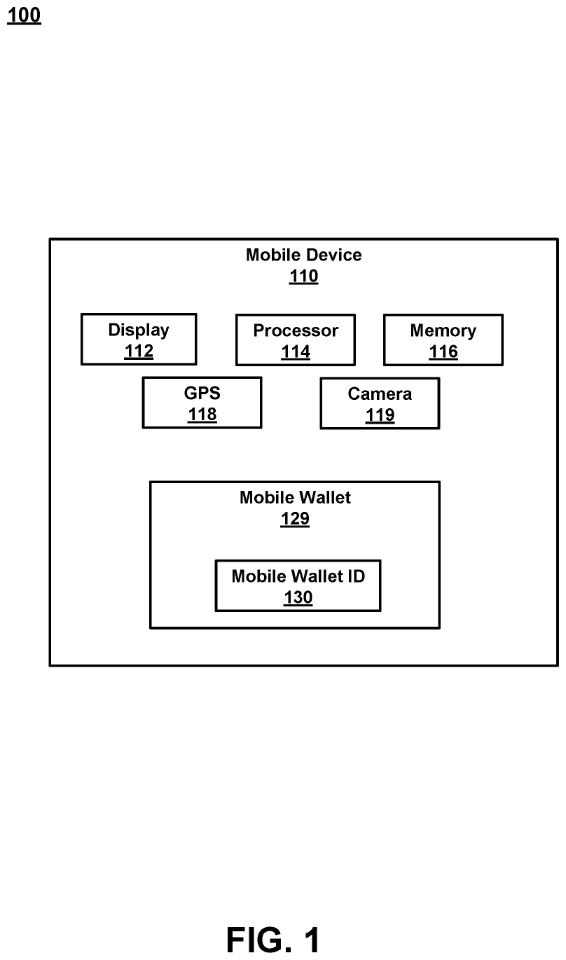

Referring now to FIG. 1, a block diagram of a mobile device 110 is shown. Although a number of components are shown as part of mobile device 110, it should be appreciated that other, different, more, or fewer components may be found on mobile device 110.

In general, mobile device 110 is an example of a customer's mobile device, a store's mobile device, an associate's mobile device, or the like. Mobile device 110 could be a mobile phone, a smart phone, a tablet, a smart watch, a piece of smart jewelry, smart glasses, or other user portable devices having wireless connectivity. For example, mobile device 110 would be capable of broadcasting and receiving via at least one network, such as, but not limited to, WiFi, Cellular, Bluetooth, NFC, and the like. In one embodiment, mobile device 110 includes a display 112, a processor 114, a memory 116, a GPS 118, a camera 119, and the like. In one embodiment, instead of providing GPS information, the location of mobile device 110 may be determined within a given radius, such as the broadcast range of an identified beacon, a WiFi hotspot, overlapped area covered by a plurality of mobile telephone signal providers, or the like.

Mobile device 110 also includes a mobile wallet 129 which is an electronic application that operates on mobile device 110. Mobile wallet 129 includes mobile wallet ID 130. In general, mobile wallet ID 130 allows a customer to utilize a single mobile payment method that is linked to one or more credit account information, reward account information, offers, coupons, and the like, and is carried in a secure digital form on a mobile device 110. Instead of using a physical plastic card to make purchases, a mobile wallet allows a customer to pay via mobile device 110 in stores, in apps, or on the web.

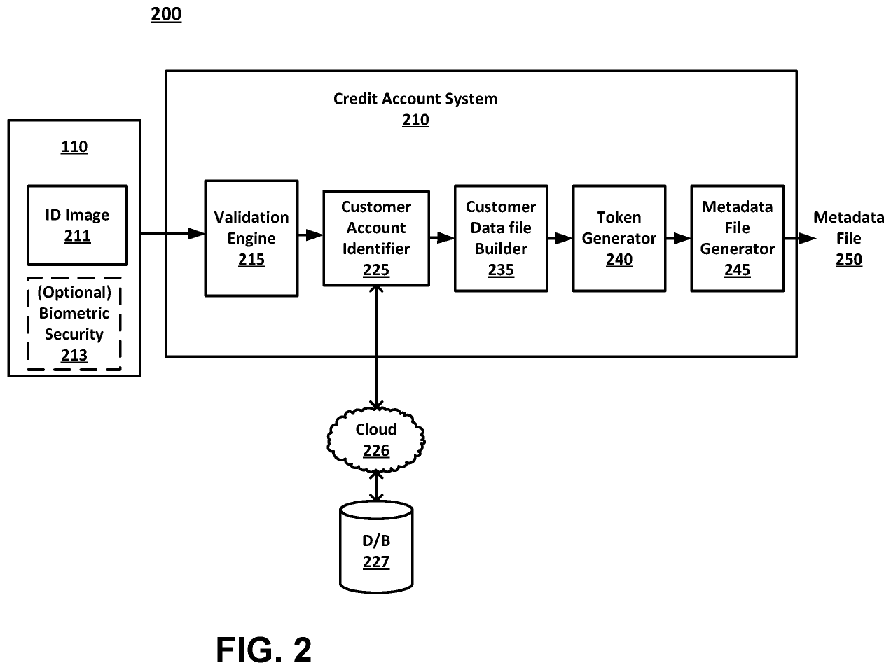

With reference now to FIG. 2, a block diagram of a system 200 for adding a customer ID with purchase capability to mobile wallet 129 of a customer's mobile device 110 is shown in accordance with an embodiment. FIG. 2 includes mobile device 110, ID image 211, optional biometric security 213, credit account system 210, cloud 226, database 227, and metadata file 250.

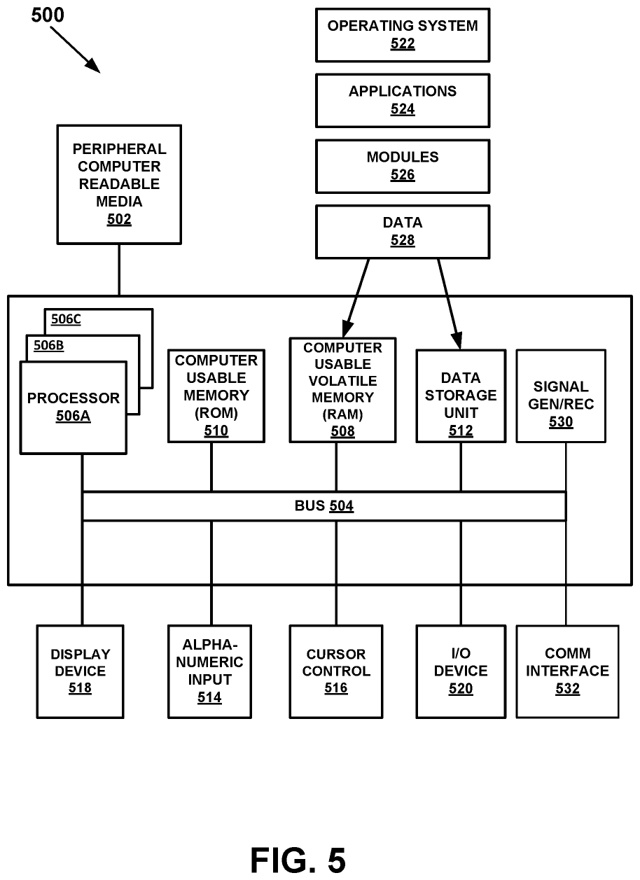

In one embodiment, credit account system 210 is a computing system such as computer system 500 described in detail in the FIG. 5 discussion herein. In one embodiment, credit account system 210 includes a validation engine 215, a customer account identifier 225, a customer data file builder 235, a token generator 240, and a metadata file generator 245.

In one embodiment, credit account system 210 receives an image of a customer's identification (e.g., ID image 211) at validation engine 215 from mobile device 110 (e.g., via the cloud 226, mobile network, WiFi, or the like). In another embodiment, credit account system 210 receives the ID image 211 from a website that has been accessed by mobile device 110 (e.g., via the cloud 226, or the like).

In general, validation engine 215 includes an ID type determiner to determine an ID type for the customer's ID image 211 and obtains a valid ID layout for the determined ID type. Validation engine 215 uses a valid ID layout comparator to compare the image of the customer's ID image 211 with the valid ID layout for the determined ID type to validate the ID image 211 of the customer's ID.

In one embodiment customer account identifier 225 utilizes customer identification information from ID image 211 to identify the customer based on the validated image of the customer's ID. Customer account identifier 225 then accesses database 227 which stores a plurality of customer credit accounts.

In one embodiment, customer account identifier 225 accesses database 227 via cloud 226. An example of cloud 226 is a network such as the Internet, local area network (LAN), wide area network (WAN), or the like. Database 227 may include store specific data, brand specific data, retailer specific data, a shared database, a conglomerate database, a portion of a larger storage database, and the like. Moreover, database 227 could be a local database, a virtual database, a cloud database, a plurality of databases, or a combination thereof.

Customer account identifier 225 searches database 227 for one or more customer credit accounts, of the plurality of customer credit accounts within database 227, that are held by the identified customer. Once one or more customer credit accounts for the identified customer are found, they are provided by the customer account identifier 225 to customer data file builder 235 which links the one or more customer accounts with the validated image of the customer's ID to build a customer data file.

In one embodiment, database 227 also stores a plurality of customer reward accounts (and/or offers, coupons, and the like) and Customer account identifier 225 searches database 227 for one or more customer reward accounts (and/or offers, coupons, and the like), of the plurality of customer reward accounts (and/or offers, coupons, and the like) within database 227, that are held by the identified customer. Once one or more customer reward accounts (and/or offers, coupons, and the like) for the identified customer are found, they are provided by the customer account identifier 225 to customer data file builder 235 which links the one or more customer reward accounts (and/or offers, coupons, and the like) held by the identified customer to the customer data file.

Token generator 240 then generates a token identifying the customer data file. In one embodiment, the token is an identification number, hash, or other type of anti-tamper encrypted protection that is generated as an identifier for the customer data file.

Metadata file generator 245 generates a metadata file 250 formatted for mobile wallet 129. The metadata file 250 includes the validated image of the customer's ID and the token as mobile wallet ID 130. In one embodiment, the mobile wallet ID 130 could be a version of ID image 211 that includes the token embedded within the image data. In another embodiment, the token could be separate from the image that is presented when mobile wallet ID 130 is accessed and would be provided at the time of the transaction. For example, the token could be provided via a near field communication (NFC) between the mobile device 110 and the POS when mobile wallet ID 130 is presented at the POS. In another embodiment, the entire mobile wallet ID 130 metadata file 250 could be provided via NFC at the time of the transaction and no imagery would be obtained by the POS even if it was presented on the display 112. In one embodiment, metadata file 250 includes an instruction that causes the validated image of the customer's ID and the token (e.g., mobile wallet ID 130) to be presented in a first location of mobile wallet 129 on the customer's mobile device 110.

The metadata file 250 is then provided from the credit account system 210 (e.g., a credit provider computer system, third-party computing system, or the like) to the customer's mobile device 110. The metadata file 250 is added to mobile wallet 129 on the customer's mobile device 110, wherein an access of the metadata file 250 in the mobile wallet causes the validated image of the customer's ID and the token (e.g., mobile wallet ID 130) to be presented by the customer's mobile device 110. Moreover, the presentation of mobile wallet ID 130 by the customer's mobile device 110 is utilized to provide payment at a time of a customer purchase as described herein.

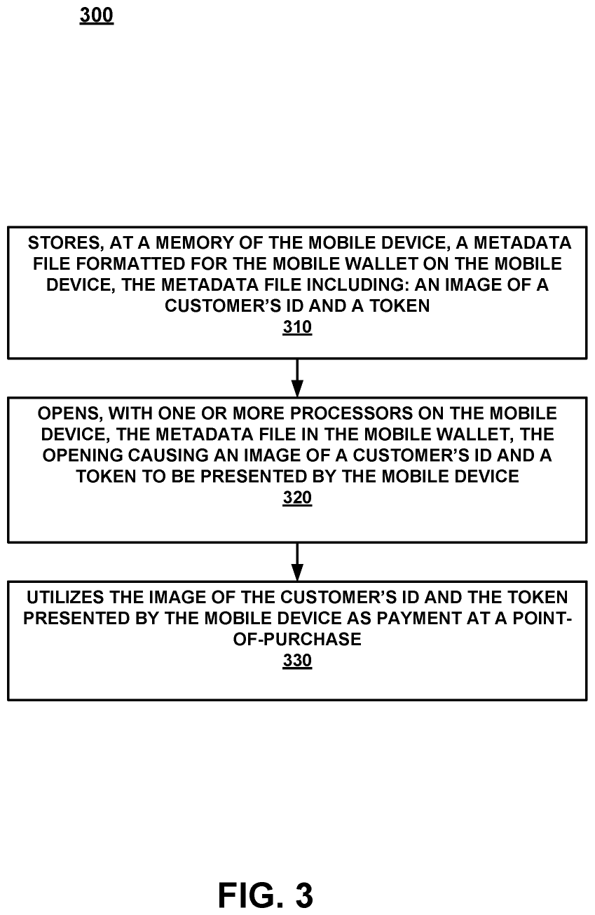

FIG. 3 is a flow diagram 300 of a method for utilizing a mobile wallet ID 130 in mobile wallet 129 of a mobile device, to make a transaction, in accordance with an embodiment.

Referring now to 310 of FIG. 3, one embodiment stores, at a memory of the mobile device, a metadata file formatted for the mobile wallet 129 on the mobile device 110. The metadata file 250 includes an image of a customer's ID and a token.

In one embodiment, to add the mobile wallet ID 130 to mobile wallet 129, a customer's ID is imaged (e.g., using a camera 119 of the mobile device 110) front and/or back by the customer's mobile device 110. Once the ID image 211 is obtained (or images if it is front and back), ID image 211 is subjected to the validation system before it is added to the mobile wallet. For example, after the ID image 211 is/are obtained by the customer's mobile device 110, they are provided to credit account system 210. In one embodiment, credit account system 210 is specific to a credit account provider. However, in another embodiment, credit account system 210 could be a third-party validation system, etc.

When credit account system 210 receives ID image 211, an ID type is determined. For example, an image matching software, OCR, or the like is used to identify the type of ID that is provided. For example, the ID could be a driver's license, a passport, a military ID, a state issued ID, a foreign country issued ID, or the like. Once the ID type is identified, credit account system 210 would access an ID layout database, website, etc. and perform a validation determination. For example, if the ID is a military ID, the validation engine 215 could access a military ID validation webpage, a credit account provider's database that has the ID details for a number of different ID's that include military ID's, etc.

Once the ID type is determined and the details about a valid ID of the same type are obtained, validation engine 215 would determine if ID image 211 is valid. For example, does ID image 211 conform to the requirements, layout, data, identifying characteristics, holograms, colors, valid dates, spacing, orientation, information, decals, blacklight wording, state specific layout, front side and back side evaluation, and the like that are provided in the obtained valid ID descriptive details. If the customer-provided image(s) does conform, then the image(s) of the ID would be verified as a valid ID image 211

In one embodiment, once the image(s) of the ID is validated, validation engine 215 would provide the validated image(s) to the customer account identifier 225 to identify and link any customer accounts to the validated ID image. In one embodiment, the customer account identifier 225 is specific to a given credit account provider. However, in another embodiment, customer account identifier 225 could be a third-party system. In one embodiment, credit account system 210 would then build a customer data file that would include the validated image(s) and one or more credit accounts, reward accounts, promotion memberships, and the like. In one embodiment, the customer data file would be added to a database such as database 227. The database could be specific to a credit account provider, a rewards program provider, a third-party data storage system, or the like.

Once the customer data file was built, a token (e.g., an identification number, hash, or other type of anti-tamper encrypted protection) would be generated for the customer data file. The token would then be added to a metadata file 250 that would be built to meet any format, database, size, and storage requirements that were necessary for proper display and utilization in a customer's mobile wallet on the mobile device 110. For example, the metadata file 250 would include the image(s) of the ID and the token in a mobile wallet format. The metadata file 250 would then be provided to the customer's mobile device 110 and upon reception added to the customer's mobile wallet 129 as mobile wallet ID 130.

With reference now to 320 of FIG. 3, one embodiment opens, with one or more processors on the mobile device 110, the metadata file in mobile wallet 129. The opening causes mobile wallet ID 130 (in one embodiment, an image of a customer's ID and the token) to be presented by the mobile device 110. For example, after the metadata file 250 is added to the customer's mobile wallet 129, mobile wallet ID 130 would be accessible in the mobile wallet in the same way that any other items are accessed by mobile wallet 129. In one embodiment, the metadata file 250 could also include information that would ensure that the mobile wallet ID 130 is on the top of the mobile wallet stack. For example, when the customer opened the mobile wallet application, mobile wallet ID 130 would be the first in the mobile wallet stack of other payment cards, tickets, etc.

With reference now to 330 of FIG. 3 and to FIG. 2, one embodiment utilizes the image of the customer's ID and the token presented by the mobile device as payment at a point-of-purchase, POS, associate's mobile checkout device, etc.

For example, when the customer goes to a shop and intends to use a credit account linked to mobile wallet ID 130 during checkout, the customer would present mobile wallet ID 130 to the POS (or other checkout system such as an associate's mobile device, etc.). When mobile wallet ID 130 is presented at checkout, it could include the transmission of the token via a near field communication (NFC), a scan of the mobile wallet ID 130 image, a scanning of a barcode provided with mobile wallet ID 130, etc. In general, since the mobile wallet ID 130 has already been validated, the token would be provided in conjunction with the image of the ID. The token, metadata, barcode, and/or image(s) would be provided from the POS to the credit account provider which would validate the token and link the purchase to the appropriate customer credit account. The credit account provider would then provide the authorization for the purchase to the POS and the transaction would be completed.

In another embodiment, when mobile wallet ID 130 is presented to the POS it would be subjected to an additional validation. For example, the customer would present mobile wallet ID 130 via the digital wallet. The POS (or other store computing device) could scan or identify the mobile wallet ID 130 and utilize a processor to determine the type of ID that is being presented. Once the ID type is determined (e.g., the ID is a Delaware driver's license), then the POS could access a Delaware driver's license layout (E.g., via a Delaware state webpage, a credit account provider database that has the ID details for a number of different ID's stored therein, or the like), and would determine if the ID conforms to the requirements and, as such, is verified as a valid Delaware state ID.

In addition to obtaining ID image 211, the token, and/or validating the ID, the transaction could also include information from the device such as user biometric information, location information (e.g., provided by a GPS), the transaction time, the transaction date, etc. In one embodiment, the location information provided by the mobile device will include time and date stamp information. In another embodiment, the location, time and/or date could be obtained from the POS, a combination of the customer's mobile device and the POS, etc.

In one embodiment, for the transaction to occur, mobile wallet ID 130 would be validated using the internet connection from the POS, the biometric information for the customer identified by the ID (as provided via a token or the like) from the customer's mobile device, the location obtained from the mobile device, the time, the date of the transaction initiation, the mobile device identification number, etc.

In so doing, the security of the customer's mobile wallet ID 130 payment system would be seamless and nearly instantaneous to the customer and the associate ringing up the transaction, but would include a plurality of checks and balances performed by the credit account provider, the brand, or a fraud determining evaluator assigned to make fraud mitigation determinations and/or evaluations.

In one embodiment, the customer could use mobile wallet ID 130 when applying for a new credit account. For example, the customer would be in Frank's Sweats store and see an offer (e.g., for a new credit account, a rewards program, etc.). The customer could provide mobile wallet ID 130 as a response to the offer. In one embodiment, mobile wallet ID 130 would be used as an account look-up, customer identifier, etc., and information within the customer data file linked to mobile wallet ID 130 would be used to complete some or all portions of the application for a new credit account, reward membership, etc.

In one embodiment, the customer would then receive the completed (or partially completed) application and provide the required legal authorization to obtain the new account. Once the new account was legally authorized by the customer, the new account information would be added to the customer data file that is linked to mobile wallet ID 130. Then, when the customer used mobile wallet ID 130 in a Frank's Sweats store (or online at Frank's Sweats website), mobile wallet ID 130 would use the new credit account, apply the rewards to the new rewards program, etc. Similarly, if the customer data file included a Bob's bicycle reward program, when the customer used mobile wallet ID 130 at Bob's bicycle, the appropriate Bob's bicycle credit account, reward program, etc. would be identified within the customer data file and utilized during the transaction. As such, the customer would not need to identify which account should be used, but instead the appropriate account would be determined from the store using mobile wallet ID 130 to initiate the transaction and the purchasing details would be obtained from the customer data file.

In one embodiment, the customer could identify a default credit account to be utilized as the source of payment when mobile wallet ID 130 is utilized and no specific credit account is recognized. For example, if the customer was purchasing a meal at a restaurant, the customer would provide mobile wallet ID 130 at the time of payment. The customer data file would not include any credit account that correlated with the restaurant and would then utilize the default credit account to provide payment.

In one embodiment, the customer could have a reward program that was linked to the restaurant and as such, when mobile wallet ID 130 was utilized, the customer data file would identify and apply the appropriate reward program information with the default credit account payment. As such, the customer would obtain the reward program points, discount, etc. and also pay for the meal without having to do more than present mobile wallet ID 130 at time of payment.

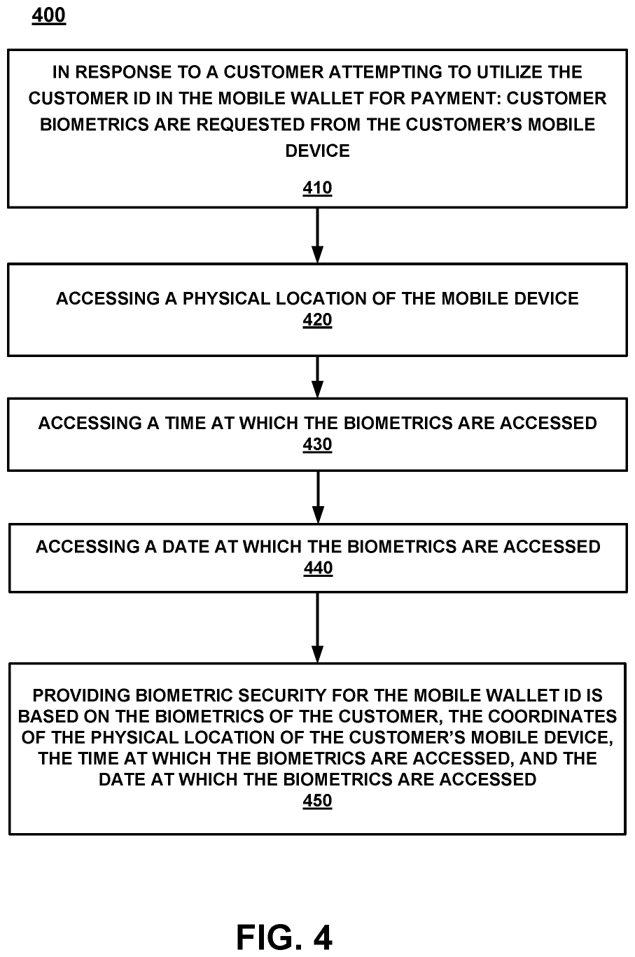

With reference now to FIG. 4, a flow diagram 400 for providing biometric security is shown, according to various embodiments. In general, the security pertains to determining that the customer who is utilizing the mobile device is actually the customer whose ID is being provided via the mobile wallet. The security described herein, enables authentication of the customer by way of biometrics. Biometrics can include, but are not limited to, thumb print scanning, voice detection, heart rate monitoring, eye/cornea detection, etc.

For example, if biometric security is enacted, or is deemed needed based on a risk factor, or the like, in order for the customer ID in the mobile wallet to be utilized, biometric information will be requested to ensure the customer is properly identified.

In one embodiment, in addition to requiring biometric information, the transaction requirements could also include additional security parameters such as one or more of date, time and location. The additional security parameters may be determined at the moment in which the biometric information is accessed at mobile device 110. Additionally, the security parameters may also be accessed by various features of the mobile device, such as a GPS 118.

For example, when the customer provides the biometric information (e.g., fingerprint) at mobile device 110, the additional security parameters (e.g., date, time, and location) are determined by GPS 118. In particular, in response to the provided biometric information, GPS 118 determines the physical location of the mobile device 110 that includes a time and/or date stamp. In one embodiment, location information could be obtained by a device separate from mobile device 110. For example, location information could be obtained by systems such as, but not limited to, a geo-fence, a node (e.g., a beacon, WiFi node, an RFID node, a mobile phone provider node), an address, a lat-long, or the like.

In one embodiment, location information that is obtained outside of the customer's mobile device is provided to mobile device 110 such that it can be transmitted along with (in conjunction with, appended to, provided within, etc.) the mobile wallet ID metadata. In one embodiment, location information that is obtained outside of the customer's mobile device is transmitted separate from the mobile wallet ID metadata or from a device other than the customer's mobile device 110, such as a POS, store mobile device, beacon, etc. In one embodiment, if the location information is transmitted separately, it will be tied to the mobile wallet ID metadata via a common identifier, such as, but not limited to, a customer number, a customer's mobile device ID, or the like. As such, if the mobile wallet ID metadata and the location information are received separately, they can be correlated at a later time by the common identifier.

In one embodiment, if the biometric information is approved in combination with one or more of the additional security parameters, then the mobile wallet ID can be used to perform the purchase.

In one example, the customer may have pre-approved location parameters in order to be authenticated. That is, if a location of the customer (or customer's mobile device) is determined to be within a location parameter, then the mobile wallet ID can be used. In the alternative, if a location of the customer is determined to be outside of a location parameter, then mobile wallet ID cannot be used. For example, if, at the time the biometrics are obtained and approved, the customer is within a 50-mile radius of his/her home address (which is the pre-approved location parameter), the customer is authenticated, and the mobile wallet ID can be used. However, if, at the time the biometrics are obtained and approved, the customer is outside of the 50-mile radius of his/her home address (which is not a pre-approved location parameter), the customer is not authenticated, and the mobile wallet ID cannot be used to make a purchase.

In one embodiment, pre-approved time and/or date parameters are used to enable customer authentication. For example, if a date and/or time at which the biometric information is obtained correspond to a pre-approved time and/or date, then the customer is authenticated (if the biometric information is also authenticated) and the mobile wallet ID can be used. In one exemplary situation, the customer may have a pre-approved (or expected) time parameter of 9:00 AM to 7:00 PM. If biometric information is obtained in the pre-approved time frame, then the customer is authenticated, and the mobile wallet ID can be used. However, if the biometric information is obtained outside of the pre-approved time frame, then the customer is not authenticated, and the mobile wallet ID cannot be used.

At 410, in response to a customer initiating access to the mobile wallet ID executing on the mobile device 110, biometrics of the customer are obtained. For example, the security procedure to authenticate the customer includes accessing biometric information (e.g., fingerprint). The biometric information can be captured by mobile device 110 (e.g., scanning of a finger for the fingerprint).

At 420, accessing a physical location of the mobile device. For example, when a customer attempts to use the mobile wallet ID for payment or even access the mobile wallet ID, the customer is authenticated. The security procedure for authentication includes accessing the physical location of the customer (which is the physical location of the mobile device assuming that the mobile device is in proximity to the customer). In one embodiment, the physical location is determined by GPS 118.

At 430, a time at which the biometrics information is accessed is established. In one embodiment, the procedure also includes establishing a time when the physical location is determined. In one embodiment, a time stamp provided by GPS 118 is used to establish the time.

At 440, a date at which the biometrics are accessed is established. In one embodiment, the time stamp provided by GPS 118 determines the date.

At 450, the security of the mobile wallet ID is based on the biometrics of the customer, the physical location of the mobile device, the time at which the biometrics were accessed, and the date when the biometrics are accessed. In one embodiment, the date, time and location at which the biometric information is accessed is compared to an approved or expected date, time and location of the customer. If the date, time and location are approved and/or expected (as well as approved biometric information), then the customer is authenticated.

It is noted that any of the procedures, as stated above, regarding flow diagram 400 may be implemented in hardware, or a combination of hardware with firmware and/or software. For example, any of the procedures may be implemented by a processor(s) of a cloud environment and/or a computing environment.

### Example Computer System

With reference now to FIG. 5, portions of the technology for providing a communication composed of computer-readable and computer-executable instructions that reside, for example, in non-transitory computer-readable medium (or storage media, etc.) of a computer system. That is, FIG. 5 illustrates one example of a type of computer that can be used to implement embodiments of the present technology. FIG. 5 represents a system or components that may be used in conjunction with aspects of the present technology. In one embodiment, some or all of the components described herein may be combined with some or all of the components of FIG. 5 to practice the present technology.

FIG. 5 illustrates an example computer system 500 used in accordance with embodiments of the present technology. It is appreciated that computer system 500 of FIG. 5 is an example only and that the present technology can operate on or within a number of different computer systems including general purpose networked computer systems, embedded computer systems, routers, switches, server devices, user devices, various intermediate devices/artifacts, stand-alone computer systems, mobile phones, personal data assistants, televisions and the like. As shown in FIG. 5, computer system 500 of FIG. 5 is well adapted to having peripheral computer readable media 502 such as, for example, a disk, a compact disc, a flash drive, and the like coupled thereto.

Computer system 500 of FIG. 5 includes an address/data/control bus 504 for communicating information, and a processor 506A coupled to bus 504 for processing information and instructions. As depicted in FIG. 5, computer system 500 is also well suited to a multi-processor environment in which a plurality of processors 506A, 506B, and 506C are present. Conversely, computer system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled to bus 504 for storing information and instructions for processors 506A, 506B, and 506C.

Computer system 500 also includes computer usable non-volatile memory 510, e.g., read only memory (ROM), coupled to bus 504 for storing static information and instructions for processors 506A, 506B, and 506C. Also present in computer system 500 is a data storage unit 512 (e.g., a magnetic disk drive, optical disk drive, solid state drive (SSD), and the like) coupled to bus 504 for storing information and instructions. Computer system 500 can also optionally include an alpha-numeric input device 514 including alphanumeric and function keys coupled to bus 504 for communicating information and command selections to processor 506A or processors 506A, 506B, and 506C. Computer system 500 can also optionally include a cursor control device 516 coupled to bus 504 for communicating user input information and command selections to processor 506A or processors 506A, 506B, and 506C. Cursor control device may be a touch sensor, gesture recognition device, and the like. Computer system 500 of the present embodiment can optionally include a display device 518 coupled to bus 504 for displaying information.

Referring still to FIG. 5, display device 518 of FIG. 5 may be a liquid crystal device, cathode ray tube, OLED, plasma display device or other display device suitable for creating graphic images and alpha-numeric characters recognizable to a user. Cursor control device 516 allows the computer user to dynamically signal the movement of a visible symbol (cursor) on a display screen of display device 518. Many implementations of cursor control device 516 are known in the art including a trackball, mouse, touch pad, joystick, non-contact input, gesture recognition, voice commands, bio recognition, and the like. In addition, special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands.

Computer system 500 is also well suited to having a cursor directed by other means such as, for example, voice commands. Computer system 500 also includes an I/O device 520 for coupling computer system 500 with external entities. For example, in one embodiment, I/O device 520 is a modem for enabling wired or wireless communications between computer system 500 and an external network such as, but not limited to, the Internet or intranet. A more detailed discussion of the present technology is found below.

Referring still to FIG. 5, various other components are depicted for computer system 500. Specifically, when present, an operating system 522, applications 524, modules 526, and data 528 are shown as typically residing in one or some combination of computer usable volatile memory 508, e.g. random access memory (RAM), and data storage unit 512. However, it is appreciated that in some embodiments, operating system 522 may be stored in other locations such as on a network or on a flash drive; and that further, operating system 522 may be accessed from a remote location via, for example, a coupling to the internet. In one embodiment, the present technology, for example, is stored as an application 524 or module 526 in memory locations within RAM 508 and memory areas within data storage unit 512. The present technology may be applied to one or more elements of described computer system 500.

Computer system 500 also includes one or more signal generating and receiving device(s) 530 coupled with bus 504 for enabling computer system 500 to interface with other electronic devices and computer systems. Signal generating and receiving device(s) 530 of the present embodiment may include wired serial adaptors, modems, and network adaptors, wireless modems, and wireless network adaptors, and other such communication technology. The signal generating and receiving device(s) 530 may work in conjunction with one (or more) communication interface 532 for coupling information to and/or from computer system 500. Communication interface 532 may include a serial port, parallel port, Universal Serial Bus (USB), Ethernet port, Bluetooth, thunderbolt, near field communications port, WiFi, Cellular modem, or other input/output interface. Communication interface 532 may physically, electrically, optically, or wirelessly (e.g., via radio frequency) couple computer system 500 with another device, such as a mobile phone, radio, or computer system.

Computer system 500 is only one example of a suitable computing environment and is not intended to suggest any limitation as to the scope of use or functionality of the present technology. Neither should the computing environment be interpreted as having any dependency or requirement relating to any one or combination of components illustrated in the example computer system 500.

The present technology may be described in the general context of computer-executable instructions, such as program modules, being executed by a computer. Generally, program modules include routines, programs, objects, components, data structures, etc., that perform particular tasks or implement particular abstract data types. The present technology may also be practiced in distributed computing environments where tasks are performed by remote processing devices that are linked through a communications network. In a distributed computing environment, program modules may be located in both local and remote computer-storage media including memory-storage devices.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended claims is not necessarily limited to the specific features or acts described above. Rather, the specific features and acts described above are disclosed by way of illustration and as example forms of implementing the claims and their equivalents.

What is claimed is:

1. A system comprising:
a network connection to receive an image of a customer's identification (ID);
a validation engine to validate the image of the customer's ID;
a customer account identifier to:
identify the customer via the validated image of the customer's ID; and
link the validated image of the customer's ID with one or more customer credit accounts held by the identified customer to build a customer data file;
an encrypted account identifier to generate a token for the customer data file; and
a mobile wallet formatter to:
build a metadata file that will comply with a mobile wallet format, the metadata file comprising the validated image of the customer's ID and the token.

2. The system of claim 1, wherein the image of the customer's ID is received from a customer's mobile device.

3. The system of claim 1, wherein the validation engine comprises:
a processor configured to:
determine an ID type for the customer's ID;
obtain a valid ID layout for the determined ID type; and
compare the image of the customer's ID with the valid ID layout for the determined ID type to validate the image of the customer's ID.

4. The system of claim 3, wherein the ID type is determined by an identifier from the group consisting of: an image matching software, and an optical character recognition.

5. The system of claim 3, wherein the validation engine further comprises:
an ID layout database that includes a plurality of valid ID layouts for a plurality of different ID types.

6. The system of claim 3, wherein the validation engine compares ID characteristics from the group consisting of: an image requirement, a layout, a data, an identifying characteristic, a hologram, a color, a valid date, a spacing, an orientation, a decal, a blacklight word, a state specific layout, a front-side and back-side evaluation, a front-side evaluation, and a back-side evaluation.

7. The system of claim 1, further comprising:
a database that stores a plurality of customer credit accounts; and
a processor to:
identify the customer based on the validated image of the customer's ID; and
search the database for one or more customer credit accounts of the plurality of customer credit accounts that are held by the identified customer.

8. The system of claim 7, wherein the database:
stores a plurality of customer reward accounts; and
the processor is further to:
search the database for one or more customer reward accounts of the plurality of customer reward accounts that are held by the identified customer; and
link the one or more customer reward accounts held by the identified customer to the customer data file.

9. The system of claim 1, wherein the metadata file further comprises:
an instruction that causes the validated image of the customer's ID and the token to be presented in a first location of the mobile wallet on a customer's mobile device.

10. The system of claim 1, further comprising:
a customer's mobile device comprising:
a memory storing instructions; and
one or more processors, executing the instructions, to:
receive, the metadata file formatted for the mobile wallet; and
add the metadata file to a mobile wallet on the customer's mobile device, wherein an access of the metadata file in the mobile wallet causes the validated image of the customer's ID and the token to be presented by the customer's mobile device, and
a presentation of the validated image of the customer's ID and the token by the customer's mobile device utilized to provide payment at a time of a customer purchase.

11. A method for utilizing an image of a customer's ID, in a mobile wallet of a mobile device, to make a transaction, the method comprising:
storing, at a memory of the mobile device, a metadata file formatted for the mobile wallet on the mobile device, the metadata file comprising:
an image of a customer's ID; and
a token;
opening, with one or more processors on the mobile device, the metadata file in the mobile wallet,
the opening causing the image of a customer's ID and the token to be presented by the mobile device; and
utilizing the image of the customer's ID and the token presented by the mobile device as payment at a point-of-purchase.

12. The method of claim 11, further comprising:
receiving via a network connection, at a credit provider computer system and from the mobile device, the image of the customer's ID;
validating the image of the customer's ID, the validating comprising:
determining an ID type for the customer's ID;
obtaining a valid ID layout for the determined ID type; and
comparing the image of the customer's ID with the valid ID layout for the determined ID type to validate the image of the customer's ID.

13. The method of claim 12, further comprising:
accessing, at the credit provider computer system, a database storing a plurality of customer credit accounts;
identifying a customer based on the validated image of the customer's ID;
searching the database for one or more customer credit accounts of the plurality of customer credit accounts that are held by the identified customer;
linking the validated image of the customer's ID with the one or more customer credit accounts held by the identified customer to build a customer data file;
generating the token, the token identifying the customer data file; and
generating the metadata file formatted for the mobile wallet of the mobile device.

14. A system comprising:
a credit provider computer system, the credit provider computer system comprising:
an Internet connection to receive an image of a customer's identification (ID);
a validation engine to validate the image of the customer's ID, the validation engine comprising:
an ID type determiner to determine an ID type for the customer's ID and obtain a valid ID layout for the determined ID type; and
a valid ID layout comparator to compare the image of the customer's ID with the valid ID layout for the determined ID type to validate the image of the customer's ID;
a database that stores a plurality of customer credit accounts; and
a processor to:
identify a customer based on the validated image of the customer's ID;
search the database for one or more customer credit accounts of the plurality of customer credit accounts that are held by the identified customer;
link the validated image of the customer's ID with the one or more customer credit accounts held by the identified customer to build a customer data file;
generate a token to identify the customer data file; and
generate a metadata file formatted for a mobile wallet, the metadata file comprising the validated image of the customer's ID and the token; and
a customer's mobile device comprising:
a memory storing instructions; and
one or more processors, executing the instructions, to:
receive, from the credit provider computer system, the metadata file formatted for the mobile wallet; and
add the metadata file to a mobile wallet on the customer's mobile device, wherein an access of the metadata file in the mobile wallet causes the validated image of the customer's ID and the token to be presented by the customer's mobile device, and
wherein a presentation of the validated image of the customer's ID and the token by the customer's mobile device utilized to facilitate payment at a time of a customer purchase.

15. The system of claim 14, wherein the ID determiner determines the ID type from the group consisting of: an image matching software, and an optical character recognition.

16. The system of claim 14, wherein the validation engine further comprises:
an ID layout database that includes a plurality of valid ID layouts for a plurality of different ID types.

17. The system of claim 14, wherein the valid ID layout comparator compares ID characteristics from the group consisting of: an image requirement, a layout, a data, an identifying characteristic, a hologram, a color, a valid date, a spacing, an orientation, a decal, a blacklight word, a state specific layout, a front-side and back-side evaluation, a front-side evaluation, and a back-side evaluation.

18. The system of claim 14, wherein the database of the credit provider computer system stores a plurality of customer reward accounts; and
the processor is further to:
search the database for one or more customer reward accounts of the plurality of customer reward accounts that are held by the identified customer; and
link the one or more customer reward accounts held by the identified customer to the customer data file.

19. The system of claim 14, wherein the metadata file further comprises:
an instruction that causes the validated image of the customer's ID and the token to be presented in a first location of the mobile wallet on the customer's mobile device.

20. The system of claim 14, wherein the customer's mobile device further comprises:
an image capturing device, the image capturing device to capture the image of the customer's ID; and
a mobile network connection to provide the image of the customer's ID to the validation engine.
